(19) United States
(12) Patent Application Publication
(10) Pub. No.: US 2020/0290303 A1
(43) Pub. Date: Sep. 17, 2020

(54) PACKAGING MACHINE AND SYSTEMS

(71) Applicant: Packsize LLC, Salt Lake City, UT (US)

(72) Inventors: Johan Blomberg, Uppsala (SE); Niklas Pettersson, Västerås (SE)

(21) Appl. No.: 16/814,509

(22) Filed: Mar. 10, 2020

Related U.S. Application Data
(60) Provisional application No. 62/818,570, filed on Mar. 14, 2019.

(51) Int. Cl. B31B 50/00; B31B 50/04; B31B 50/06

(52) U.S. Cl. CPC B31B 50/006; B31B 2120/30; B31B 50/06; B31B 50/042

(57) ABSTRACT

A converting assembly performs a plurality of conversion functions on sheet material to convert the sheet material into packaging templates. The converting assembly includes a plurality of tool rollers. Each of the tool rollers has one or more conversion tools thereon. The one or more conversion tools on an individual tool roller are configured to perform a subset of the plurality of conversion functions that convert the sheet material into packaging templates.

### CROSS-REFERENCE TO RELATED APPLICATIONS

This application claims priority to and the benefit of U.S. Patent Application Ser. No. 62/818,570, filed Mar. 14, 2019, entitled “Packaging Machine and Systems,” the disclosure of which is incorporated herein by this reference.

### BACKGROUND

### 1. The Technical Field

Exemplary embodiments of the disclosure relate to systems, methods, and devices for converting raw material into packaging templates.

### 2. The Relevant Technology

Shipping and packaging industries frequently use paperboard and other sheet material processing equipment that converts sheet materials into box templates. One advantage of such equipment is that a shipper may prepare boxes of required sizes as needed in lieu of keeping a stock of standard, pre-made boxes of various sizes. Consequently, the shipper can eliminate the need to forecast its requirements for particular box sizes as well as to store pre-made boxes of standard sizes. Instead, the shipper may store one or more bales of fanfold material, which can be used to generate a variety of box sizes based on the specific box size requirements at the time of each shipment. This allows the shipper to reduce storage space normally required for periodically used shipping supplies as well as reduce the waste and costs associated with the inherently inaccurate process of forecasting box size requirements, as the items shipped and their respective dimensions vary from time to time.

In addition to reducing the inefficiencies associated with storing pre-made boxes of numerous sizes, creating custom sized boxes also reduces packaging and shipping costs. In the fulfillment industry it is estimated that shipped items are typically packaged in boxes that are about 65% larger than the shipped items. Boxes that are too large for a particular item are more expensive than a box that is custom sized for the item due to the cost of the excess material used to make the larger box. When an item is packaged in an oversized box, filling material (e.g., Styrofoam, foam peanuts, paper, air pillows, etc.) is often placed in the box to prevent the item from moving inside the box and to prevent the box from caving in when pressure is applied (e.g., when boxes are taped closed or stacked). These filling materials further increase the cost associated with packing an item in an oversized box.

Customized sized boxes also reduce the shipping costs associated with shipping items compared to shipping the items in oversized boxes. A shipping vehicle filled with boxes that are 65% larger than the packaged items is much less cost efficient to operate than a shipping vehicle filled with boxes that are custom sized to fit the packaged items. In other words, a shipping vehicle filled with custom sized packages can carry a significantly larger number of packages, which can reduce the number of shipping vehicles required to ship the same number of items. Accordingly, in addition or as an alternative to calculating shipping prices based on the weight of a package, shipping prices are often affected by the size of the shipped package. Thus, reducing the size of an item's package can reduce the price of shipping the item. Even when shipping prices are not calculated based on the size of the packages (e.g., only on the weight of the packages), using custom sized packages can reduce the shipping costs because the smaller, custom sized packages will weigh less than oversized packages due to using less packaging and filling material.

Although sheet material processing machines and related equipment can potentially alleviate the inconveniences associated with stocking standard sized shipping supplies and reduce the amount of space required for storing such shipping supplies, previously available machines and associated equipment have various drawbacks. For instance, previous systems have included cutting and creasing tools that require time-consuming movements and/or repositioning in order to make cuts and creases in the sheet material. As a result, the throughput of such machines has been limited.

Accordingly, it would be advantageous to have a packaging machine that can form box templates in a faster and more efficient manner.

### BRIEF SUMMARY

Exemplary embodiments of the disclosure relate to systems, methods, and devices for forming packaging templates. For instance, one embodiment of a converting assembly is configured to perform a plurality of conversion functions on sheet material to convert the sheet material into packaging templates. The converting assembly includes a plurality of tool rollers. Each of the tool rollers has one or more conversion tools thereon. The one or more conversion tools on an individual tool roller are configured to perform a subset of the plurality of conversion functions that convert the sheet material into packaging templates.

According to another embodiment, a converting machine is configured to convert sheet material into packaging templates. The converting machine includes a feed changer configured to selectively feed sheet materials having different characteristics into the converting machine. The converting machine also includes a converting assembly that is configured to perform a plurality of conversion functions on the sheet material to convert the sheet material into packaging templates. The converting assembly includes at least first and second roller sets. The first roller set includes a first tool roller on a first axle. The first tool roller includes one or more transverse conversion tools thereon. The first tool roller is selectively rotatable on or about the first axle to selectively engage the one or more transverse conversion tools thereon with the sheet material. The second roller set includes at least first and second tool rollers on a second axle. Each of the first and second tool rollers on the second axle includes one or more transverse conversion tools and/or one or more longitudinal conversion tools thereon. The first and second tool rollers on the second axle are selectively rotatable on or about the second axle to selectively engage the one or more transverse conversion tools and/or the one or more longitudinal conversion tools thereon with the sheet material. The first and second tool rollers are selectively movable along a length of the second axle to reposition the one or more transverse conversion tools and/or the one or more longitudinal conversion tools relative to the sheet material. The movements of the first and second tool rollers may be symmetrical about a centerline of the converting assembly.

According to another embodiment, a method is provided for performing a plurality of conversion functions on sheet material to convert the sheet material into packaging templates. The method includes performing a first subset of conversion functions of the plurality of conversion functions on the sheet material with one or more tool rollers on a first axle. The method also includes performing a second subset of conversion functions of the plurality of conversion functions on the sheet material with one or more tool rollers on a second axle.

These and other objects and features of the present disclosure will become more fully apparent from the following description and appended claims, or may be learned by the practice of the disclosure as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a schematic view of an example system for forming packaging templates.

FIGS. 2A-2C illustrate an example converting assembly for converting sheet material into packaging templates.

FIG. 3 illustrates another example converting assembly for converting sheet material into packaging templates.

FIG. 4 illustrates an example printing arrangement for printing on packaging templates.

FIGS. 5A, 5B, 6A, 6B, and 6C illustrate example mechanisms for preventing the sheet material from undesirably folding up.

### DETAILED DESCRIPTION

The embodiments described herein generally relate to systems, methods, and devices for forming packaging templates. While the present disclosure will be described in detail with reference to specific configurations, the descriptions are illustrative and are not to be construed as limiting the scope of the present disclosure. Various modifications can be made to the illustrated configurations without departing from the spirit and scope of the invention as defined by the claims. For better understanding, like components have been designated by like reference numbers throughout the various accompanying figures.

As used herein, the term “bale” shall refer to a stock of sheet material that is generally rigid in at least one direction, and may be used to make a box template. For example, the bale may be formed of a continuous sheet of material or a sheet of material of any specific length, such as corrugated cardboard and paperboard sheet materials. Additionally, the bale may have stock material that is substantially flat, folded, or wound onto a bobbin.

As used herein, the term “box template” shall refer to a substantially flat stock of material that can be folded into a box-like shape. A box template may have notches, cutouts, divides, and/or creases that allow the box template to be bent and/or folded into a box. Additionally, a box template may be made of any suitable material, generally known to those skilled in the art. For example, cardboard or corrugated paperboard may be used as the box template material. A suitable material also may have any thickness and weight that would permit it to be bent and/or folded into a box-like shape.

As used herein, the term “crease” shall refer to a line along which the box template may be folded. For example, a crease may be an indentation in the box template material, which may aid in folding portions of the box template separated by the crease, with respect to one another. A suitable indentation may be created by applying sufficient pressure to reduce the thickness of the material in the desired location and/or by removing some of the material along the desired location, such as by scoring.

The terms “notch,” “cutout,” and “cut” are used interchangeably herein and shall refer to a shape created by removing material from the template or by separating portions of the template, such that a divide through the template material is created.

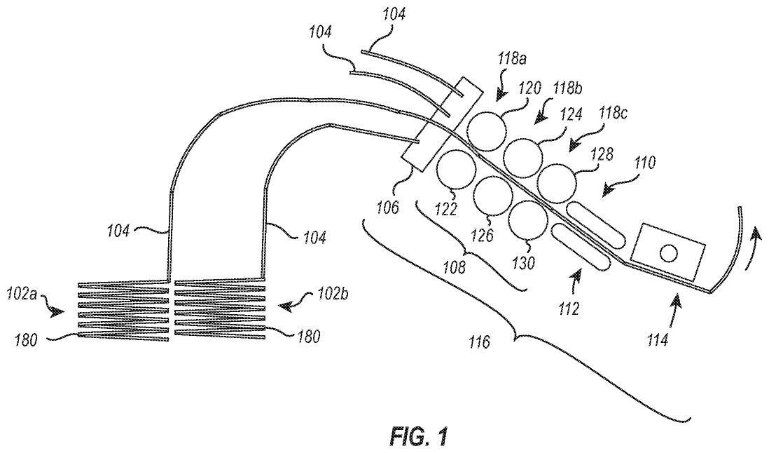

FIG. 1 illustrates an example system 100 that may be used to create packaging templates (and optionally erected boxes therefrom). The system 100 includes bales 102 (e.g., bales 102a, 102b) of sheet material 104. The system 100 also includes a feed changer 106 and a converting assembly 108. Optionally, the system 100 may also include a print assembly 110, a folding and attachment assembly 112, and/or an erecting assembly 114. Combinations of one or more of the feed changer 106, the converting assembly 108, the print assembly 110, the fold and attachment assembly 112, and/or the erecting assembly 114 may form a converting machine 116.

Generally, the feed changer 106 is configured to advance the sheet material 104 from a desired bale 102a, 102b into the converting assembly 108. The bales 102a, 102b may be formed of sheet material 104 that have different characteristics (e.g., widths, lengths, thickness, stiffness, color, etc.) from one another. For instance, the width of the bale 102b may be smaller than the width of the bale 102a. Thus, it may be desirable to use the sheet material 104 from the bale 102b to form a smaller box so there is less sheet material wasted (e.g., side trim).

Although FIG. 1 illustrates bales 102 of sheet material 104 being used as the source material from which packaging templates can be made, it will be appreciated that this is only exemplary. In other embodiments, the sheet material 104 may come from a source that is unfolded. For instance, the sheet material 104 may take the form of an endless or continuous sheet that has not been folded. As used herein, an endless or continuous sheet may simply refer to sheet material that is significantly longer than required to form a single packaging template or that is long enough to form multiple packaging templates therefrom. In other embodiments, the sheet material 104 may be formed by joining or splicing together individual panels or sheets of sheet material.

After the sheet material 104 passes through the feed changer 110, the sheet material 104 passes through the converting assembly 108, where one or more conversion functions are performed on the sheet material 104 to form a packaging template from the sheet material 104. The conversion functions may include cutting, creasing, bending, folding, perforating, and/or scoring the sheet material 104 in order to form a packaging template therefrom.

As the packaging template exits the converting assembly 108, the print assembly 110 may print labels, logos, instructions, or other material on the packaging template. The packaging template may also optionally be folded and glued by the folding and attachment assembly 112 (e.g., to form a manufacturer's joint). Furthermore, the erecting assembly 114 may also optionally erect the folded and glued packaging temple into an open box that is ready to be filled with product(s).

As can be seen in FIG. 1, the feed changer 106 can accept sheet material 104 from multiple bales 102. The position of at least a portion of the feed changer 106 can be adjusted relative to the converting assembly 108 such that the desired sheet material 104 is aligned with and can be fed into the converting assembly 108. For instance, the sheet material 104 from a particular bale 102 may be desired because of one or more characteristics of the sheet material (e.g., width, thickness, color, strength, etc.). The feed changer 106 may be adjusted so that the desired sheet material 104 from the appropriate bale 102 is positioned to be fed into the converting assembly 108. In FIG. 1, for instance, the feed changer 106 is adjusted to feed sheet material 104 from the bale 102a into the converting assembly 108.

In some embodiments, the feed changer 106 is configured to adjust on the fly. For instance, the feed changer 106 may be configured to change which sheet material 104 is fed into the converting assembly 108 even while the converting assembly 108 completes the conversion functions on a previous packaging template.

As the sheet material 104 advances through the converting assembly 108, one or more converting tools (discussed in greater detail below) perform conversion functions (e.g., crease, bend, fold, perforate, cut, score) on the sheet material 104 in order to create packaging templates out of the sheet material 104. Some of the conversion functions may be made on the sheet material 104 in a direction substantially perpendicular to the direction of movement and/or the length of the sheet material 104. In other words, some conversion functions may be made across (e.g., between the sides) the sheet material 104. Such conversion functions s may be considered “transverse conversions” or “transverse conversion functions.” In contrast, some of the conversion functions may be made on the sheet material 104 in a direction substantially parallel to the direction of movement and/or the length of the sheet material 104. Such conversions may be considered “longitudinal conversions” or “longitudinal conversion functions.” The converting assembly 108 may also or alternatively perform one or more angled and/or curved conversion functions on the sheet material 104. Such angled and/or curved conversion functions may extend at least partially along the length of the sheet material and at least partially between opposing side edges thereof. Furthermore, some of the conversion functions may include cutting excess material off of the sheet material 104. For instance, if the sheet material 104 is wider than needed to form a desired packaging template, part of the width of the sheet material 104 can be cut off by one or more conversion tools.

In the embodiment illustrated in FIG. 1, the converting assembly 108 includes a series of roller sets 118 (e.g., roller sets 118a, 118b, 118c). Each roller set 118 may include one or more converting tools for performing the conversion functions on the sheet material 104. For instance, in some embodiments, roller set 118a may include one or more conversion tools that are configured to make cuts and/or creases along all or portions of the width of the sheet material 104. Similarly, in some embodiments, roller set 118b may include one or more conversion tools that are configured to make cuts and/or creases along all or portions of the length of the sheet material 104. Likewise, in some embodiments, roller set 118c may include one or more conversion tools for making transverse and/or longitudinal cuts (e.g., to form flaps of the packaging template).

In some embodiments, each roller set 118 may include one or more rollers that include the conversion tools (referred to herein as tool rollers) and one or more opposing rollers (referred to herein as support rollers) opposite thereto. For instance, FIG. 1 illustrates roller set 118a with a tool roller 120 and a support roller 122, roller set 118b with a tool roller 124 and a support roller 126, and roller set 118c with a tool roller 128 and support roller 130.

In the illustrated embodiment, the tool rollers 120, 124, 128 are disposed on one side (e.g., above) of the sheet material 104 and the support rollers 122, 126, 130 are disposed on an opposite side (e.g., below) of the sheet material 104. In other embodiments, the tool rollers 120, 124, 128 may be positioned below the sheet material 104 and the support rollers 122, 126, 130 may be position above the sheet material 104. In still other embodiments, some of the tool rollers 120, 124, 128 may be positioned above the sheet material 104 and some of the tool rollers 120, 124, 128 may be positioned below the sheet material 104. In such embodiments, some of the support rollers 122, 126, 130 may be positioned above the sheet material 104 and some of the support rollers 122, 126, 130 may be positioned below the sheet material 104. In still other embodiments, at least one of the tool rollers 120, 124, 128 may be positioned above the sheet material 104 and at least one of the tool rollers 120, 124, 128 may be positioned below the sheet material 104 and generally opposite to the tool roller that is above the sheet material 104. In such embodiment, the opposing tool rollers may both perform conversion functions on the sheet material and act as a support roller for the opposing tool roller (e.g., the top tool roller may act as a support roller for the bottom tool roller and the bottom tool roller may act as a support roller for the top tool roller).

As used herein, relative positional terms, such as “top,” “bottom,” “above,” and “below,” are merely used for convenience. In at least some embodiments, such terms should be understood to mean that the referenced element is positioned to one side or another of another element. For example, as noted above, some of the tool rollers 120, 124, 128 and the support rollers 122, 126, 130 can be positioned on one side or another of the sheet material 104. In some embodiments, some of the tool rollers 120, 124, 128 and/or the support rollers 122, 126, 130 may actually be positioned above or below the sheet material 104. In other embodiments, however, some of the tool rollers 120, 124, 128 and/or the support rollers 122, 126, 130 may merely be positioned to one side or another of the sheet material. Thus, reference herein to tool rollers and/or support rollers as being “top” or “bottom” rollers or positioned “above” or “below” the sheet material is intended to broadly cover the tool rollers and/or support rollers being positioned to one side or another of the sheet material, regardless of whether the sheet material is oriented horizontally, vertically, or angled (e.g., such as shown in FIG. 1).

In some embodiments, each of the tool rollers in a given roller set 118 may be mounted on a common axle and/or along a common axis. Similarly, in some embodiments, each of the support roller in a given roller set 118 may be mounted on a common axle and/or along a common axis. The support rollers may provide a support surface for the sheet material 104 as the tool rollers perform the conversion functions thereon. In some embodiments, the rotation of the support rollers (and optionally the tool rollers) may also assist with advancing the sheet material 104 through the converting assembly 108.

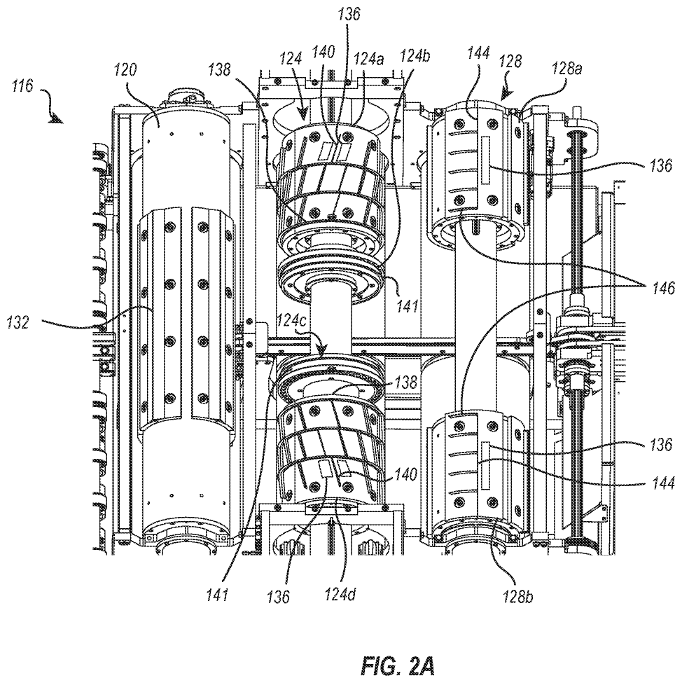

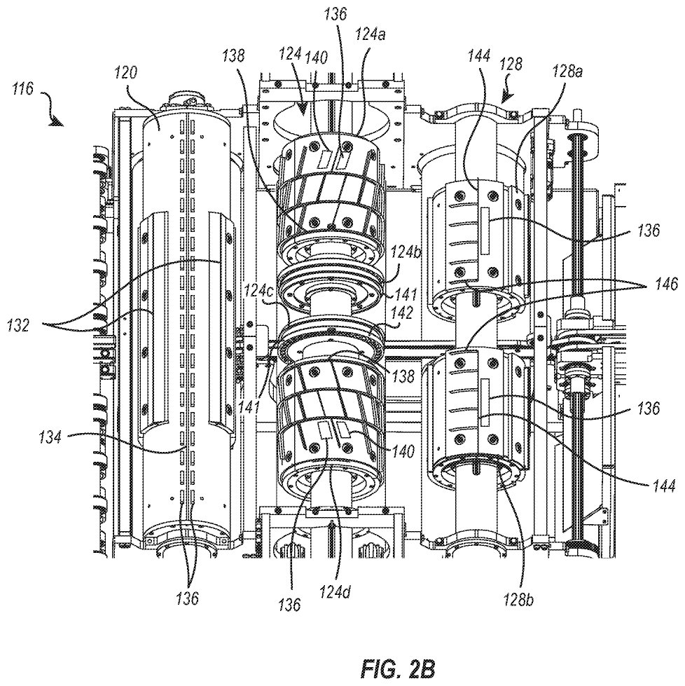

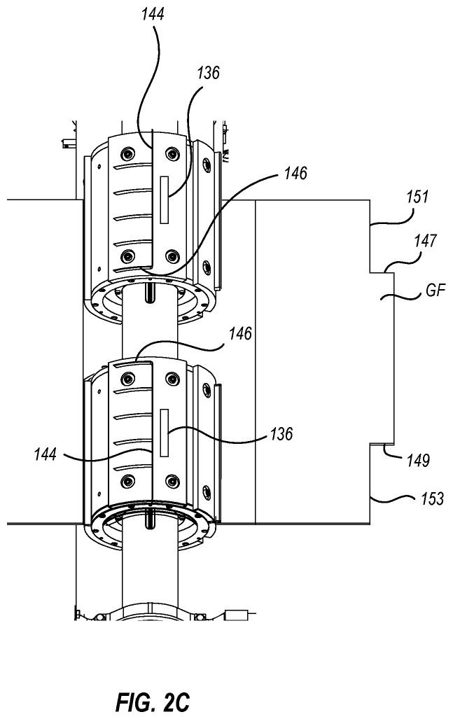

Attention is now directed to FIGS. 2A and 2B, which illustrate an example embodiment of the converting assembly 116. More particularly, FIGS. 2A and 2B primarily illustrate example embodiments of the tool rollers 120, 124, 128 of the converting assembly 116. While FIGS. 2A and 2B illustrate a particular configuration of the tool rollers 120, 124, 128, it will be appreciated that the illustrated and described embodiment is merely exemplary and the tool rollers may be rearranged, fewer or more tool rollers may be used, and/or the conversion tools thereof may be rearranged or redistributed among the rollers 120, 124, 128 or fewer or more tool rollers.

In the illustrated embodiment, the tool roller 120 is mounted on a first axle or about a first axis to enable the tool roller 120 to rotate thereabout. The tool roller 120 may include one or more creasing tools 132 disposed thereon. As seen in FIGS. 2A and 2B, the creasing tool(s) 132 may be a ridge or projection formed on or extending radially from the outer surface of the tool roller 120. When the tool roller 120 is rotated so that a creasing tool 132 engages the sheet material 104, the creasing tool 132 can form a crease in the sheet material 104. More specifically, the creasing tool 132 may cooperate with the support roller 122 (FIG. 1) to compress or make an indentation in the sheet material 104, thereby forming a crease in the sheet material 104.

In some embodiments, the creasing tool(s) 132 may be permanently attached or integrated into the tool roller 120. In other embodiments, the creasing tool(s) 132 may be selectively attachable to or removable from the tool roller 120. In the illustrated embodiment, the creasing tool(s) 132 extend along at least a portion of the length of tool roller 120. In some embodiment, one or more of the creasing tools 132 may extend continuously along a least a portion of the length of tool roller 120. In other embodiments, one or more of the creasing tools 132 may extend discontinuously along a least a portion of the length of tool roller 120 (e.g., such that there are gaps between portions of the creasing tool 132). The one or more creasing tools 132 may be disposed at one or more distinct locations about the circumference of the tool roller 120. In some embodiments, one or more of the creasing tools 132 may extend at least partially around the circumference of the tool roller 120.

As can be seen in FIG. 2B, the tool roller 120 may also include one or more separation knives 134. The separation knife 134 illustrated in FIG. 2B may be a knife or blade formed on or extending radially from the outer surface of the tool roller 120. When the tool roller 120 is rotated so that the separation knife 134 engages the sheet material 104, the separation knife 134 can form a cut in the sheet material 104. In some embodiments, at least one separation knife 134 extends along all or a substantial portion of the width of the converting assembly 108. As such, the separation knife 134 can be configured to form a cut along the entire width of the sheet material 104 in order to separate the sheet material 104 into separate pieces. Once such a separation cut is made, the feed changer 106 may change what sheet material 104 will be fed into the converting assembly 108 next.

In some embodiments, the tool roller 120 may include one or more resilient members adjacent to the creasing tool(s) 132 and/or the separation knife(ves) 134. For instance, as shown in FIG. 2B, the tool roller 120 includes resilient members 136 on opposing sides of the separation knife 134. In the illustrated embodiment, the resilient members 136 include a plurality of resilient members 136 disposed along opposing sides of the separation knife 134. In other embodiments, the tool roller 120 may include one or more resilient members 136 on a single side of the separation knife 134, one or more resilient members 136 on each side of the separation knife 134, or a single resilient member 136 on one side of the separation knife 134 and a plurality of resilient members 136 on an opposing side thereof. Likewise, the one or more resilient members 136 may be disposed on one or both sides of one or more of the creasing tool(s) 132.

The resilient member(s) 136 may be formed of rubber, foam, or other materials or devices (e.g., springs) that can be compressed and then expand back to an original size. The resilient member(s) 136 can provide various functionalities to the tool roller 120. For instance, the resilient member(s) 136 can be compressed between the tool roller 120 and the sheet material 104 when a creasing tool 132 or a separation knife 134 is rotated to engage the sheet material 104. As the tool roller 120 rotates to disengage the creasing tool 132 or the separation knife 134 from the sheet material 104, the expansion of the resilient member 136 can assist with withdrawing the creasing tool 132 or the separation knife 134 from the sheet material 104. The resilient member(s) 136 may also engage the sheet material 104 during rotation of the tool roller 120 to assist with advancing the sheet material 104 through the converting assembly 108.

With continued attention to FIGS. 2A and 2B, attention is now to directed to tool roller 124. In the illustrated embodiment, the tool roller 124 is formed of four tool rollers 124a, 124b, 124c, 124d which are mounted on a second axle or about a second axis. In the illustrated embodiment, the second axle or second axis is substantially parallel to the first axle or first axis.

The tool rollers 124a, 124b, 124c, 124d include one or more conversion tools that can be used to perform one or more conversion functions on the sheet material 104. For instance, the tool rollers 124a and 124d each include a side trim knife 138. In some embodiments, the side trim knives 138 extend around all or a substantial portion of the circumferences of the tool rollers 124a, 124d and radially therefrom. The side trim knives 138 may be oriented perpendicular to the second axle or axis and generally parallel to the length of the sheet material 104. In this configuration, the side trim knives 138 are configured to trim off the sides of the sheet material 104 when the sheet material 104 is wider than necessary to form a desired packaging template. In some embodiments, the side trim knives 138 can continuously engage the sheet material 104 if the sheet material 104 is wider than necessary to make a desired packaging template. In other embodiments, if the sheet material 104 is already the proper width to make a desired packaging template, the side trim knives 138 may not engage the sheet material 104.

The tool rollers 124a, 124d may also include one or more additional knives 140, as shown in FIGS. 2A and 2B. The knives 140 may be configured to cut the side trim from the sheet material 104 into smaller pieces. In some embodiments, the knives 140 extend primarily parallel to the second axle or axis. However, as can be seen in FIGS. 2A and 2B, the knives 140 can extend at least partially around the circumference of the tool rollers 124a, 124d. Thus, the knives 140 can be angled or perpendicular to the second axle or axis. In addition to side trim knives 140, some embodiments may include one or more trim attraction elements for attracting the pieces of side trim. In some embodiments, the one or more trim attraction elements may include one or more blowers, fans, vacuums, or static generation elements that can attract or direct the side trim to a desired area.

Similar to the tool roller 120, the tool rollers 124a, 124d may include one or more resilient members 136 disposed on one or more sides of the conversion tools, including the side trim knives 138 and the knives 140.

The tool rollers 124b, 124c may include creasing tools 141 for forming longitudinal creases in the sheet material 104. The creasing tools 141 may include ridges or other projections that extend radially out from the tool rollers 124b, 124c. In some embodiments, the creasing tools 141 may extend around all or substantially all of the circumferences of the tool rollers 124b, 124c. The creasing tools 141 on the tool rollers 124b, 124c may form creases in the sheet material 104 that will define boundaries between side wall panels and top and bottom flaps of the packaging template being formed.

In some embodiments, the tool rollers 124a-124d may rotate about the second axle or axis to cause the conversion tools thereon to engage or disengage the sheet material 104. Additionally, in some embodiments, the tool rollers 124a-124d may also move along the length of the second axle or axis either closer to or further away from one another. For instance, the tool rollers 124a, 124d are spaced further apart from one another in FIG. 2A than in FIG. 2B. The spacing between tool rollers 124a, 124d can be determined by the width of the packaging template being formed. For instance, the tool rollers 124a, 124d may be spaced apart from one another such that the distance between their respective side trim knives 138 is equal to the desired width of the packaging template being formed.

Similarly, the tool rollers 124b, 124c may also be moved closer together or further apart, as can be ascertained from a comparison between FIGS. 2A and 2B. The tool rollers 124b, 124c can be spaced apart so that the distance between their respective creasing tools is equal to a desired dimension of the packaging template (e.g., height of the side walls).

Furthermore, the tool rollers 124a, 124b can be spaced apart from one another by a desired dimension. Likewise, the tool rollers 124c, 124d can also be spaced apart from one another by a desired dimension. In some embodiments, the dimensions between the tool rollers 124a, 124b and between the tool rollers 124c, 124d can be equal to one another. In some embodiments, the distance between the tool rollers 124a, 124b and between the tool rollers 124c, 124d can be equal to a desired dimension of packaging template flaps.

In some embodiments, the tool rollers 124a, 124d may move symmetrically along the length of the second axle or axis. For instance, as the tool roller 124a moves towards a first end of the second axle or axis, the tool roller 124d can move in an opposite direction towards a second end of the second axle or axis. Likewise, as the tool roller 124a moves towards a longitudinal center of the second axle or axis, the tool roller 124d can likewise move in an opposite direction towards the longitudinal center of the second axle or axis. As a result, the tool rollers 124a, 124d can always be positioned an equal distance from the longitudinal center of the second axle or axis. In the same manner, tool rollers 124b, 124c may also be symmetrically mounted and movable on the second axle or axis such that the tool rollers 124b, 124c can always be positioned an equal distance from the longitudinal center of the second axle or axis.

In some embodiments, the tool roller 124 may also include one or more feed rollers 142 mounted on the second axle or about the second axis. The one or more feed rollers may rotate about the second axle or axis and engage the sheet material 104 to assist with advancing sheet material 104 through the converting assembly 108.

In some embodiments, the rotation of the second axle and/or the tool rollers 124a, 124b, 124c, 124d and the feed roller 142 may be actively driven (e.g., via one or more motors). In other embodiments, the second axle may freely rotate and/or the tool rollers 124a, 124b, 124c, 124d and the feed roller 142 may freely rotate about the second axle or axis. For instance, the second axle and/or the tool rollers 124a, 124b, 124c, 124d and the feed roller 142 may not be actively and directly driven (e.g., with one or more motors). Rather, the support roller 126 (see FIG. 1) associated with the second axle or axis may be actively driven (e.g., with a motor). Rotation of the support roller 126 and/or the movement of the sheet material 104 between the support roller 126 and tool rollers on the second axle may result in rotation of the tools and/or roller(s) on the second axle.

In some embodiments, the conversion tools on the second axle may engage and/or penetrate into the associated support roller 126. In order to reposition the tool rollers 124a, 124b, 124c, 124d along the length of the second axle or axis, the conversion tools thereon may first need to be disengaged from the support roller 126. This may be accomplished by moving the second axle away from the support roller 126, moving the support roller 126 away from the second axle, or a combination thereof via one or more actuators. Alternatively, or additionally, the tool rollers 124a, 124b, 124c, 124d may be rotated so as to rotate the conversion tools away from the support roller 126, thereby disengaging the conversion tools from the support roller 126.

Once the conversion tools are disengaged from the support roller 126, the tool rollers 124a, 124b, 124c, 124d can be repositioned along the length of the second axle or axis and the conversion tools can be reengaged with the support roller 126 (e.g., by moving the second axle towards the support roller 126, moving the support roller 126 towards the second axle, rotating the tool rollers 124a, 124b, 124c, 124d so the conversion tools engage the support roller 126, or a combination thereof).

With continuing reference to FIGS. 2A, 2B, attention is now directed to the tool roller 128. In the illustrated embodiment, tool roller 128 includes tool rollers 128a, 128b mounted on a third axle or about a third axis. In the illustrated embodiment, the third axle or axis is substantially parallel to the first and second axles or axis.

The tool rollers 128a, 128b include one or more conversion tools that can be used to perform one or more conversion functions on the sheet material 104. For instance, tool rollers 128a and 128b each include one or more flap knives 144. The one or more flap knives 144 illustrated in FIGS. 2A and 2B may be knives or blades formed on or extending radially from the outer surface of the tool rollers 128a, 128b. The one or more flap knives 144 may extend generally parallel to the third axle or axis.

When the tool rollers 128a, 128b are rotated so that the flap knives 144 engage the sheet material 104, the flap knives 144 can form cuts or notches in the sheet material 104. The cuts or notches formed by the flap knives 144 may at least partially define flaps of the packaging template. In some embodiments, the flap knives 144 extends along all or a substantial portion of the width of the tool rollers 128a, 128b.

In some embodiments, the tool rollers 128a, 128b may also include longitudinal knives 146. The longitudinal knives 146 may be oriented generally perpendicular to the third axle or axis and parallel to the length or feed direction of the sheet material 104. In some embodiments, the longitudinal knives 146 may extend around all or a portion of the circumferences of the tool rollers 128a, 128b. The longitudinal knives 146 may be rotated into engagement with the sheet material 104 to cut off portions of the sheet material 104. For instance, the longitudinal knives 146 may cut off portions of the sheet material 104 adjacent to a glue flap formed therein as part of the packaging template. For instance, as shown in FIG. 2C, the longitudinal knives 146 can be rotated to engage the sheet material 104 and form longitudinal cuts at edges 147, 149. The cuts at edges 147, 149 along with the cuts at edges 151, 153 (formed by flap knives 144) cut out excess sheet material on opposing sides of the glue flap GF.

Similar to the tool rollers 120 and 124, the tool rollers 128a, 128b may include one or more resilient members 136 disposed on one or more sides of the conversion tools, including the flap knives 144 and the longitudinal knives 146. Furthermore, like the tool rollers 120 and 124a-124d, the tool rollers 128a, 128b may rotate about the third axle or axis to cause the conversion tools thereon to engage or disengage the sheet material 104. Additionally, like the tool rollers 124a-124d, the tool rollers 128a 128b may also move symmetrically along the length of the third axle or axis either closer to or further away from one another. For instance, the tool rollers 128a, 128b are spaced further apart from one another in FIG. 2A than in FIG. 2B. The spacing between tool rollers 128a, 128b can be determined by the width of the packaging template being formed. For instance, the longitudinal knives 146 may be generally aligned with the creasing tools on the tool rollers 124b, 124c. Additionally, the ends of the flaps knives 144 closest to the longitudinal center of the third axle or axis may be spaced apart from one another such that the distance between the noted ends is equal to a desired dimension (e.g., height of the packaging template side walls) of the packaging template being formed.

In some embodiments, the tool rollers 128a, 128b may move symmetrically along the length of the third axle or axis. For instance, as the tool roller 128a moves towards a first end of the third axle or axis, the tool roller 128b can move in an opposite direction towards a second end of the third axle or axis. Likewise, as the tool roller 128a moves towards a longitudinal center of the third axle or axis, the tool roller 128b can likewise move towards the longitudinal center of the third axle or axis. As a result, the tool rollers 128a, 128b can always be positioned an equal distance from the longitudinal center of the third axle or axis.

In some embodiments, the rotation of the third axle and/or the tool rollers 128a, 128b about the third axis may be actively driven (e.g., via a motor) or freely rotate (similar to the second axle and the tool rollers thereon). In other embodiments, the conversion tools on the tool rollers 128a, 128b may be disengage from the support roller 130 (see FIG. 1) by moving the third axle away from the support roller 130, moving the support roller 130 away from the third axle, or a combination thereof via one or more actuators. Such disengagement of the conversion tools may enable the tool rollers 128a, 128b to be repositioned along the length of the third axle and the conversion tools can be reengaged with the support roller 130 (e.g., by moving the third axle towards the support roller 130, moving the support roller 130 towards the third axle, or a combination thereof).

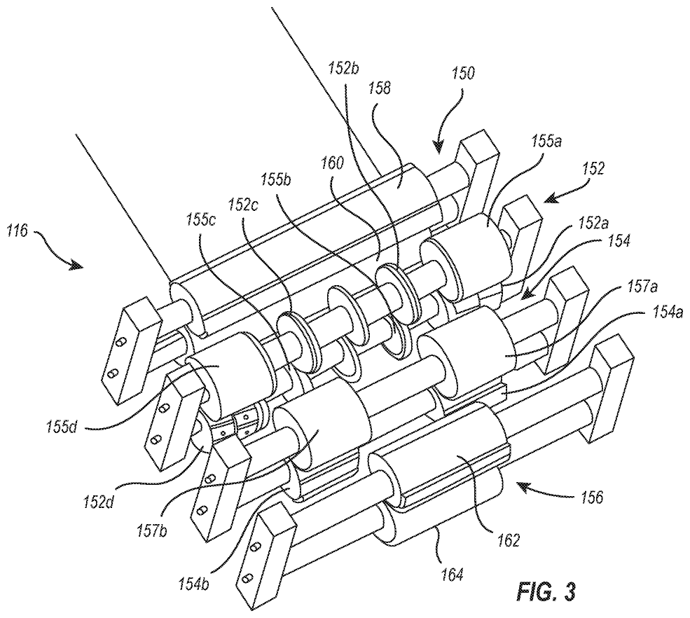

As noted above, the number of roller sets, tool rollers, and support rollers, as well as the ordering thereof and the configuration of the conversion tools thereon can be altered from one embodiment to another. By way of example, FIG. 3 illustrates another embodiment of a converting assembly 116. Many aspects of the embodiment illustrated in FIG. 3 may be similar or identical to the embodiment shown and described in connection with FIGS. 2A and 2B. According, the following description of FIG. 3 will focus primarily on the aspects that are different from the embodiment of FIGS. 2A and 2B.

As can be seen in FIG. 3, the converting assembly 116 includes a plurality of roller sets. Each roller set includes one or more tool rollers and one or more support rollers. Unlike the converting assembly of FIGS. 2A and 2B, which included three roller sets, the converting assembly of FIG. 3 includes four roller sets, namely roller sets 150, 152, 154, 156.

The roller set 150 may include a tool roller 158 and a support roller 160. The tool roller 158 may include one or more separation knives and/or resilient members, similar or identical to tool roller 120 of FIGS. 2A and 2B. Unlike tool roller 120, however, tool roller 158 does not include transverse creasing tools in the illustrated embodiment. Rather, roller set 156 includes a tool roller 162 that includes one or more transverse creasing tools, similar to the creasing tools 132 on tool roller 120. Roller set 156 also includes a support roller 164.

Roller sets 152 is substantially similar to the previously described roller set that includes tool rollers 124. For instance, the roller set 152 has similar tool rollers (and associated conversion tools) as tool roller 124. In contrast, however, the arrangement of the tool rollers and support rollers in FIG. 3 is distinct from that of FIGS. 2A and 2B. By way of example, roller set 152 includes tool rollers 152a, 152b, 152c, 152d. Rather than having a single support roller for all of the tool rollers 152a, 152b, 152c, 152d, roller set 152 includes individual support rollers 155a, 155b, 155c, 155d that correspond to tool rollers 152a, 152b, 152c, 152d.

Additionally, the positioning of the tool rollers 152a, 152b, 152c, 152d and the support rollers 155a, 155b, 155c, 155d is unique compared to the embodiment shown in FIGS. 2A and 2B. For instance, rather than having the tool rollers and the support rollers positioned on opposite side of the sheet material, some of the tool rollers 152a, 152b, 152c, 152d are positioned to be on one side of the sheet material and some are positioned to be on an opposite side thereof. Similarly, some of the support rollers 155a, 155b, 155c, 155d are positioned to be on one side of the sheet material and some are positioned to be on an opposite side thereof.

The roller set 154 is substantially similar to the previously described roller set that includes tool roller 128. For instance, the roller set 154 has similar tool rollers (and associated conversion tools) as tool roller 128. In contrast, however, the arrangement of the tool rollers and support rollers in FIG. 3 is distinct from that of FIGS. 2A and 2B. More particularly, FIG. 3 illustrates tool rollers 154a, 154b being positioned so as to be below the sheet material and the support rollers 157a, 157b being positioned so as to be above the sheet material as the sheet material is advanced through the converting assembly 116. In contrast, the tool roller 128 from FIGS. 2A and 2B are positioned to be above the sheet material and the associated support roller(s) below the sheet material.

As noted elsewhere herein, relative positional terms, such as “above” and “below,” are used merely for convenience and should not be limiting. Rather, “above” and “below” are used to simply refer to one element being positioned to one side or another of another element. Thus, for example, although the tool rollers 154a, 154b and the support rollers 157a, 157b are described as being positioned respectively “below” and “above” the sheet material, the machine may be inverted so that the tool rollers 154a, 154b and the support rollers 157a, 157b are positioned respectively “above” and “below” the sheet material. Generally, an element may be considered “above” or “below” a reference element (e.g., the sheet material) as long as the element is positioned to one side or another of the reference element, regardless of the orientation of the reference element (e.g., horizontal, vertical, diagonal, etc.).

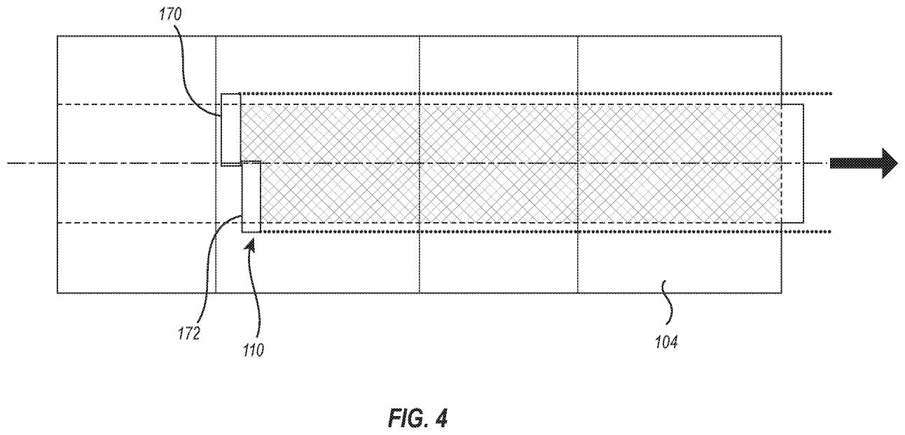

As noted above, in addition to performing conversion functions of the sheet material to create packaging templates, the converting machine 116 may optionally include a print assembly 110 for printing on packaging templates, as shown in FIGS. 1 and 4. As shown in FIG. 4, the print assembly 110 may include print heads 170, 172 (although a single print head or more than two print heads are contemplated herein).

In the illustrated embodiment, the prints heads 170, 172 are offset from one another in the feed direction of the sheet material 104. As a result, the sheet material 104 will begin passing print head 170 before the sheet material 104 begins passing print head 172. As can be seen in FIG. 4, the print heads 170, 172 are arranged so that as a set the print heads 170, 172 are centered with the sheet material 104. As a result, the print heads 170, 172 can, if desired, print on the sheet material 104 so that the printing is centered on the sheet material 104.

In some embodiments, the print heads 170, 172 can be movable relative to one another and the sheet material 104. For instances, the print heads 170, 172 may move closer to or further away from one another. In some embodiments, the movements of the print heads 170, 172 may be symmetrical about the centerline of the machine and/or the sheet material 104 (similar to the symmetrical movements of the tool rollers described above). Such symmetrical movement may allow the print heads 170, 172 to adjust for the size of packaging template that is being printed on. For instance, the print heads 170, 172 may move further apart to print on a larger packaging template and may move closer together to print on a smaller packaging temple. The offset positioning of the print heads 170, 172 may allow the print heads 170, 172 to move even closer together, even partially overlapping as shown in FIG. 4.

Attention is returned briefly to FIG. 1. As noted above, the sheet material 104 may be arranged into bales 102. To form a bale 102 with the sheet material 104, the sheet material 104 is, in this embodiment, folded back and forth on itself. Due to this folding pattern, the bales 102 are sometimes referred to as z-fold or fanfold bales. When forming a bale 102, fanfold creases 180 are formed in the sheet material 104. When the sheet material 104 is taken from the bale 102, the fanfold creases 180 are unfolded. Unfortunately, however, the fanfold creases 180 can try to refold the sheet material 104, which can cause problems when the sheet material 104 is advanced through the converting machine 116. For instance, folding of the sheet material 104 at the fanfold creases 180 can cause the sheet material 104 to become jammed in the converting machine 116.

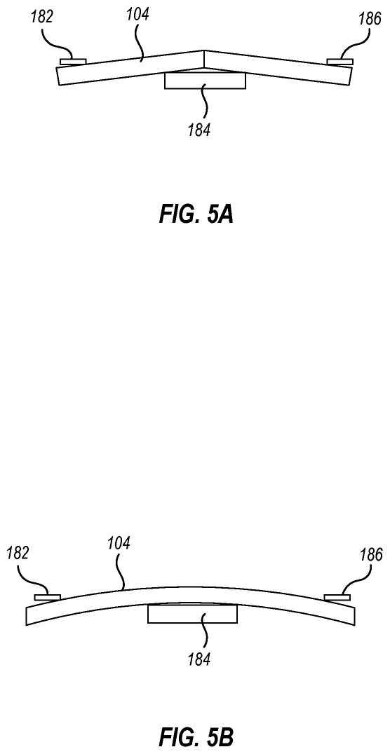

FIGS. 5A and 5B illustrate one mechanism for limiting or preventing the fanfold creases 108 from folding up the sheet material 104. FIGS. 5A and 5B illustrate a cross-sectional view of the sheet material 104 (showing the width of the sheet material 104). As can be seen, the sheet material 104 is in an arched or bowed configuration. When the sheet material 104 is in such an arched or bowed configuration, any folds (including fanfold creases 180) that extend between the opposing sides of the sheet material 104 will be forced to unfold or prevented from folding up. As a result, the sheet material 104 will be less likely to get caught or jammed in the converting machine 116.

In FIGS. 5A and 5B, the sheet material 104 is arranged or held in the arched or bowed configuration by elements 182, 184, 186. In the illustrated embodiment, elements 182, 186 engage a top surface of the sheet material 104 and element 184 engages a bottom surface of the sheet material 104. As can be seen in FIGS. 5A and 5B, the placement of element 184 relative to elements 182, 186 causes the sheet material 104 to arch or bow as shown. For instance, the lower surfaces of elements 182, 186 and the upper surface of element 184 may be generally aligned with one another. By way of example, the upper surface of element 184 may be vertically offset lower than the lower surfaces of elements 182, 186 (e.g., the surfaces may be vertically spaced apart) by a dimension that is less than the thickness of sheet material 104. In some embodiments, the upper surface of element 184 and the lower surfaces of elements 182, 186 may lie within the same vertical plane. In still other embodiments, the upper surface of element 184 may be vertically higher than the lower surfaces of elements 182, 186.

Elements 182, 184, 186 may include guide rails, belts, roller wheels, or any other suitable mechanism for arching or bowing the sheet material 104 as described. While FIGS. 5A and 5B illustrate elements 182, 186 above sheet material 104 and element 184 below sheet material 104, it will be appreciated that an inverse arrangement is contemplated, such that the sheet material 104 would arch or bow in the opposite direction.

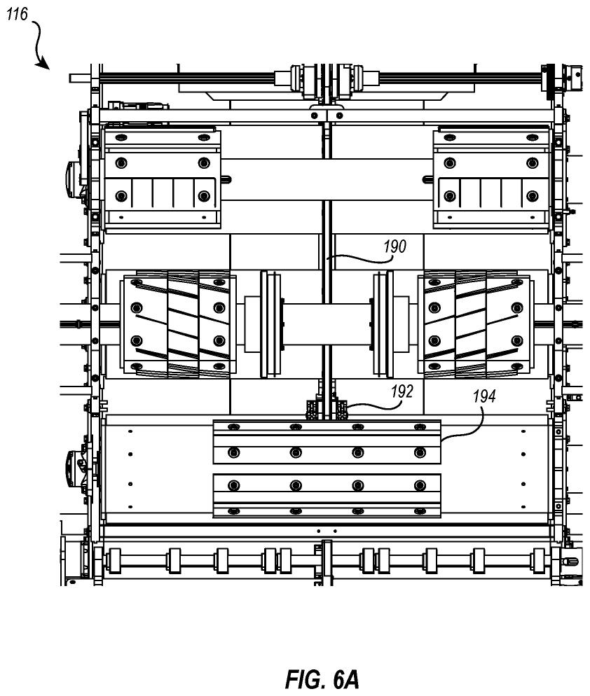

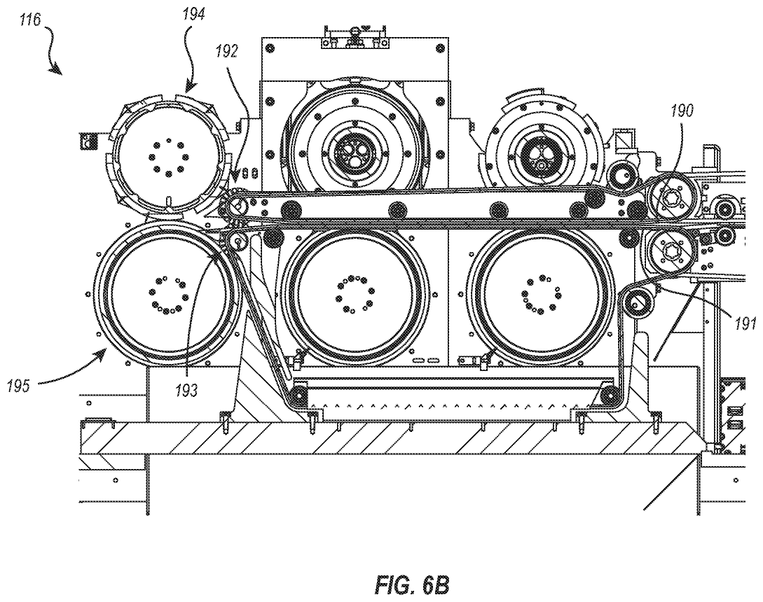

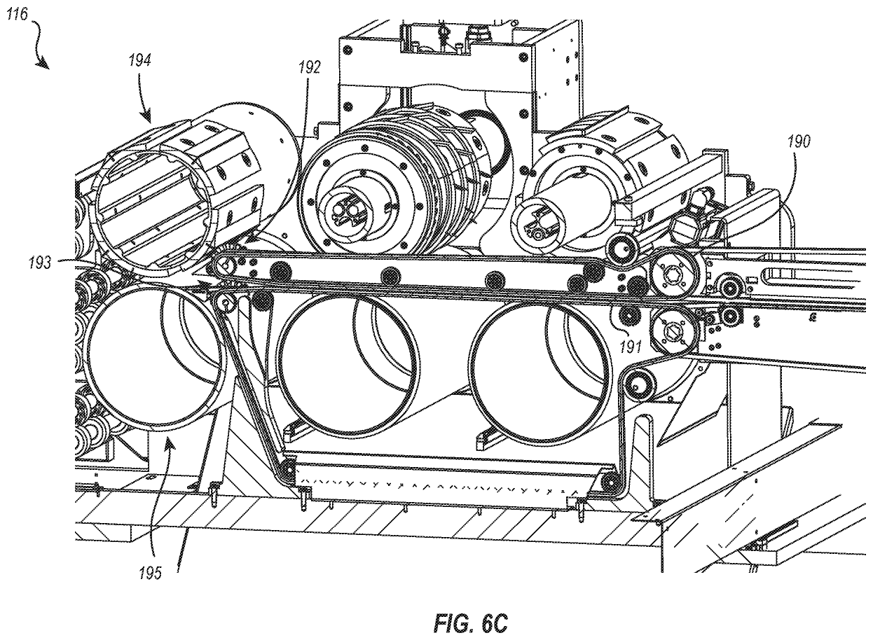

Attention is now directed to FIGS. 6A, 6B, and 6C, which illustrates other mechanisms for limiting or preventing folds (including the fanfold creases 180) from undesirably folding the sheet material 104. The mechanisms shown in FIGS. 6A, 6B, and 6C may be used in combination with or separate from one another and/or the mechanism of FIGS. 5A and 5B.

As can be seen in FIGS. 6A, 6B, and 6C, the converting assembly 116 includes opposing drive belts 190, 191 that extend at least partially therethrough and between at least some of the tool rollers and/or the support rollers. The drive belts 190, 191 can assist with advancing the sheet material 104 through the converting assembly 116. Additionally, the drive belts 190, 191 can engage the sheet material 104 to limit or prevent the sheet material 104 from folding up (e.g., at the fanfold creases 180) towards the drive belts 190, 191. While illustrated embodiment includes two drive belts (e.g., 190, 191), other embodiments may include a single drive belt (e.g., drive belt 190 or drive belt 191). Still other embodiments may include more than two drive belts.

FIGS. 6A, 6B, 6C also illustrate a series of brushes 192, 193. The brushes 192, 193 can be positioned adjacent to tool roller 194 and/or support roller 195 so that the brushes engage the sheet material 104 directly after the sheet material 104 has passed by the tool roller 194 and/or support roller 195. The brushes 192, 193 may act to limit or prevent the sheet material 104 from folding up, or even straighten out the sheet material 104 if it is folded. In some embodiments, the brushes 192, 193 limit or prevent the sheet material 104 from folding up long enough for the drive belt(s) 190, 191 and/or other drive belts to engage the sheet material 104 and limit or prevent the sheet material 104 from folding up. For example, the brushes 192, 193 may rotated in opposite direction (e.g., brushes 192 rotate counterclockwise and brushes 193 rotate clockwise in the illustrated embodiment shown in FIG. 6B), to prevent the sheet material 104 from folding in the direction of the brushes 192, 193. The peripheral speed of the brushes (e.g., near the radial tips of the brushes 192, 193) may be at least as higher or higher than the feeding speed of the sheet material 104.

A control system can control the operation of the converting machine. More specifically, the control system can control the feeding of the sheet material and the movement and/or placement of the various components of the converting machine. For instance, the control system can control the positioning of the tool rollers along the lengths of the axles or axis so that the conversion tools are positioned relative to the width of the sheet material in order to perform the conversion functions on the desired portion(s) of the sheet material. Additionally, the control system can control the rotation of the tool rollers in order to have the desired conversion tool(s) engage the sheet material at the desired location(s). In some embodiments, the control system also synchronizes the operations of the various components of the converting machines. For instance, the control system can control the feed speed of the sheet material and the rotation of the tool rollers so that the conversion tools perform the conversion functions at the desired location(s) on the sheet material.

In some embodiments, the synchronization performed by the control system is done between the times various conversion tools are engaged with the sheet material and/or the support roller(s). For instance, tool roller 120 may be rotated about the first axle or axis to disengage its conversion tools from the sheet material and/or the support roller 122. While the conversion tools of the tool roller 120 are disengaged from the sheet material, the sheet material can be (or continue to be) advanced into or through the converting assembly. Based at least in part on the speed at which the sheet material is advancing, the control system can control when and in what direction to rotate the tool roller 120 so that a particular conversion tool thereon will engage the sheet material so that the particular tool engages the proper location on the sheet material. Similarly, the rotation of the tool rollers 128a, 128b on the third axle or about the third axis can be controlled to engage or disengage particular conversion tools with the sheet material based at least in part on the speed of the sheet material advancement.

The control system can coordinate the speed of the sheet material advancement and the rotation (direction and timing) of the tool rollers so that the desired conversion tools on the various tool rollers engage the sheet material at desired locations on the sheet material. To adjust the size of the packaging templates, the control system may increase or decrease the speed of the sheet material advancement (e.g., by adjusting the rotational speed of one or more of the support rollers or drive belts) and/or the timing of when the tool rollers are rotated into engagement with the sheet material.

Furthermore, the control system can control the transverse adjustments of the tool rollers along the lengths of their respective axles or axis. For instance, in the time between engagement with portions of the sheet material that will form successive packaging templates, the control system can cause the tool rollers to be repositioned along the lengths of their respective axles or axis. By way of example, referring to FIG. 2A, after tool rollers 124a, 124b, 124c, 124d have finished performing conversion functions on a packaging template and before beginning to perform conversion functions on a subsequent packaging template, the control system can cause the tool rollers 124a, 124b, 124c, 124d to be repositioned along the second axle or axis based on the dimensions of the subsequent packaging template. The control system can coordinate such adjustment so that it takes place between successive packaging templates. In some embodiments, the control system coordinates such adjustments at least partially based on the speed of the sheet material advancement and/or the timing of when previous conversion functions (e.g., performed by the tool roller 120) were performed.

It will be appreciated that the number, placement, and ordering of the conversion tools can vary from one embodiment to another. For instance, the conversion tools may vary based on the type or style of packaging template being formed. Furthermore, while the tool rollers and the support rollers have been illustrated as having generally circular cross-sections, such is merely exemplary. For instance, in some embodiments, one or more tool rollers and/or support rollers may have a non-circular cross-section, such as oval, square, etc. It will also be appreciated that the control system can synchronize the tool rollers and/or the sheet material advancement speed in order to adjust at least some of the dimensions of the packaging template without having to replace or reorder the conversion tools.

In some embodiments, a converting machine according to the present disclosure may include one or more sensors. The one or more sensors may detect the current positions or other operating parameters of the various components of the machine (e.g., tool rollers, conversion tools, sheet material, advancement mechanisms, etc.). The one or more sensors may communicate the detected information to the control system to enable the control system to effectively and accurately control the operation of the converting machine.

In light of the above, it will be understood that a converting assembly according to the present disclosure may include a plurality of roller sets. Each roller set may include one or more tool rollers with one or more conversion tools thereon. Each roller set may also include one or more support rollers opposite the tool rollers to support the sheet material as the conversion tools perform one or more conversion functions on the sheet material. It will also be understood that the order or arrangement of the roller sets and the conversion tools associated therewith may vary from one embodiment to the next.

It will also be understood that a converting assembly as disclosed herein may provide for symmetrical movement of tool rollers on common axles or axis. For example, if an axle or axis includes a set of tool rollers, the tool rollers may move symmetrically (e.g., equal distance in opposite directions) along the length of the axle or axis. As a result, the converting assembly can form packaging templates the are symmetrical across their lengths.

It will also be understood that a converting assembly as disclosed herein may provide for asymmetrical movement of tool rollers on common axles or axis. For example, if an axle or axis includes a set of tool rollers, the tool rollers may move asymmetrically (e.g., non-equal distances and/or in common directions) along the length of the axle or axis. As a result, the converting assembly can form packaging templates the are asymmetrical across their lengths.

A converting assembly as described herein may provide a variety of benefits and advantages over existing technologies. For instance, by providing conversion tools on different rollers, including rollers on different axles or axis, the speed at which the sheet material can be converted into packaging templates of different sizes can be dramatically increased. The increased speed can be achieved, at least in part, because some of the tool rollers can be repositioned or reoriented in preparation for performing certain conversion functions while the conversion tools on other tool rollers are performing conversion functions. In other words, the converting assemblies disclosed herein can run at a continuous or nearly continuous (and usually a higher) rate. In contrast, existing technologies require starts and stops during the conversion process in order to provide time to readjust the conversion tools.

Furthermore, the ability to adjust the position and/or orientation of the tool rollers “on the fly” enables the converting assemblies disclosed herein to be particularly useful when making templates of various sizes. As used herein, adjusting the position and/or orientation of the tool rollers “on the fly” includes adjusting the position or orientation of at least some of the tool rollers after they perform conversion functions to form a first packaging template and before they perform conversion function to form a second packaging template. As used herein, adjusting the position and/or orientation of the tool rollers “on the fly” can also include adjusting the position and/or orientation of at least some of the tool rollers while some of the other tool rollers are still performing conversion functions on the sheet material. Such on the fly adjustments can significantly increase the throughput of the converting assembly. Additionally, such on the fly adjustments can allow for packaging template batch sizes as small as a single packaging template to be formed without significantly or noticeably reducing the throughput of the converting assembly.

The noted benefits are particularly useful when packaging templates of various sizes are being made, rather than large batches of one size packaging temple. For instance, in the e-commerce field, the size of to-be-packaged items can vary from one order to the next. As a result, a converting machine that can rapidly adjust to the continuously changing requirements (e.g., sizes) for packaging templates can increase the speed at which orders can be processed (e.g., packaged and shipped).

In light of the disclosure herein, a converting assembly for performing a plurality of conversion functions on sheet material to convert the sheet material into packaging templates may include a plurality of tool rollers. Each of the tool rollers may have one or more conversion tools thereon. The one or more conversion tools on an individual tool roller may be configured to perform a subset of the plurality of conversion functions that convert the sheet material into packaging templates.

In some embodiments, at least some of the plurality of tool rollers are arranged in a series adjacent to one another such that the plurality of tool rollers engage the sheet material sequentially.

In some embodiments, the plurality of tool rollers comprises a first tool roller on a first axle and at least two tool rollers on a second axle. The first tool roller may be selectively rotatable on or about the first axle to selectively engage the one or more conversion tools thereon with the sheet material. The at least two tool rollers on the second axle may be selectively rotatable on or about the second axle to selectively engage the one or more conversion tools on the at least two tool rollers with the sheet material.

In some embodiments, the first tool roller comprises one or more separation knives configured to transversely cut the sheet material into separate pieces that can be converted into separate packaging templates. The separate pieces may be arranged successively in a feeding direction of the sheet material.

In some embodiments, the first tool roller further comprises one or more transverse creasing tools configured to form transverse creases in the sheet material as part of the conversion of the sheet material into packaging templates.

In some embodiments, the first tool roller comprises one or more transverse creasing tools configured to form transverse creases in the sheet material as part of the conversion of the sheet material into packaging templates.

In some embodiments, the at least two tool rollers on the second axle comprise first and second tool rollers. Each of the first and second tool rollers comprises a longitudinal creasing tool configured to form a longitudinal crease in the sheet material as part of the conversion of the sheet material into packaging templates.

In some embodiments, the first and second tool rollers are configured to be selectively moved along a length of the second axle.

In some embodiments, the first and second tool rollers are configured to move symmetrically along the length of the second axle about a centerline of the converting assembly.

In some embodiments, the at least two tool rollers on the second axle comprises third and fourth tool rollers. Each of the third and fourth tool rollers comprises a side trim knife configured to trim off excess side trim from the sheet material as part of the conversion of the sheet material into packaging templates.

In some embodiments, the third and fourth tool rollers are configured to be selectively moved along the length of the second axle.

In some embodiments, the third and fourth tool rollers are configured to move symmetrically along the length of the second axle about a centerline of the converting assembly.

In some embodiments, each of the third and fourth tool rollers comprises one or more additional knives that are configured to cut the excess side trim from the sheet material into smaller pieces.

In some embodiments, an attraction element is included and that is configured to attract the smaller pieces of cut side trim to a desired area.

In some embodiments, the plurality of tool rollers comprises at least two tool rollers on a third axle. The at least two tool rollers on the third axle are selectively rotatable on or about the third axle to selectively engage the one or more conversion tools on the at least two tool rollers on the third axle with the sheet material.

In some embodiments, the at least two tool rollers on the third axle comprise first and second tool rollers on the third axle. Each of the first and second tool rollers on the third axle comprises one or more flap knives configured to form cuts in the sheet material to at least partially define flaps in the packaging templates.

In some embodiments, the at least two tool rollers on the third axle comprise first and second tool rollers on the third axle. Each of the first and second tool rollers on the third axle comprises one or more longitudinal knives configured to form longitudinal cuts in the sheet material.

In some embodiments, the at least two tool rollers on the third axle are configured to be selectively moved along a length of the third axle.

In some embodiments, the at least two tool rollers are configured to move symmetrically along the length of the third axle about a centerline of the converting assembly.

In some embodiments, one or more resilient members are positioned adjacent to one or more of the one or more conversion tools.

In some embodiments, a drive belt is provided to assist with advancing the sheet material through the converting assembly.

In some embodiments, the drive belt is configured to limit or prevent the sheet material from folding up or down as the sheet material advances through the sheet material.

In some embodiments, one or more brushes are positioned adjacent to at least one of the tool rollers. The one or more brushes are configured to limit or prevent the sheet material from folding up or down after the sheet material passes by the at least one of the tool rollers.

In some embodiments, one or more support rollers are provided.

In some embodiments, the one or more support rollers comprise a single support roller positioned opposite the plurality of tool rollers.

In some embodiments, the one or more support rollers comprise a support roller positioned opposite to each of the plurality of tool rollers.

In some embodiments, for at least one of the one or more conversion tools, only a portion of the at least one conversion tool is used to perform a conversion function for a packaging template having a first size and all of the at least one conversion tool is used to perform a conversion function for a packaging template having a second size.

In some embodiments, one or more of the tool rollers are configured to have their conversion tools disengaged from the sheet material and repositioned or reoriented while one or more of the other tool rollers are performing conversion functions on the sheet material.

In another embodiment, a converting machine for converting sheet material into packaging templates includes a feed changer and a converting assembly. The feed changer is configured to selectively feed sheet materials having different characteristics into the converting machine. The converting assembly is configured to perform a plurality of conversion functions on the sheet material to convert the sheet material into packaging templates. The converting assembly includes at least first and second roller sets. The first roller set comprises a first tool roller on a first axle or axis. The first tool roller comprises one or more transverse conversion tools thereon and is selectively rotatable on or about the first axle or axis to selectively engage the one or more transverse conversion tools thereon with the sheet material. The second roller set comprises at least first and second tool rollers on a second axle or axis. Each of the first and second tool rollers on the second axle or axis comprises one or more transverse conversion tools and/or one or more longitudinal conversion tools thereon. The first and second tool rollers are selectively rotatable on or about the second axle or axis to selectively engage the one or more transverse conversion tools and/or the one or more longitudinal conversion tools thereon with the sheet material. The first and second tool rollers are selectively movable along a length of the second axle or axis to reposition the one or more transverse conversion tools and/or the one or more longitudinal conversion tools relative to the sheet material.

In some embodiments, the second roller set further comprises third and fourth tool rollers on the second axle. Each of the third and fourth tool rollers comprises one or more transverse conversion tools and/or the one or more longitudinal conversion tools.

In some embodiments, the converting assembly further comprises a third roller set having at least first and second tool rollers on a third axle or axis. Each of the first and second tool rollers on the third axle or axis has one or more transverse conversion tools and/or the one or more longitudinal conversion tools.

In some embodiments, the movements of the first and second tool rollers are symmetrical about a centerline of the converting assembly.

In some embodiments, the feed changer is configured to change which sheet material is fed into the converting machine even while the converting assembly completes the conversion functions on a previous packaging template.

In some embodiments, an advancement mechanism is configured to advance the sheet material through the converting machine.

In some embodiments, the advancement mechanism comprises one or more support rollers positioned opposite to the tool roller.

In some embodiments, the advancement mechanism comprises one or more drive belts.

In some embodiments, a control system is configured to synchronize the movements of the tool rollers and a speed at which the advancement mechanism advances the sheet material through the converting machine.

In some embodiments, the control system is configured to rotate the tool rollers to engage the conversion tools with predetermined portions of the sheet material.

In some embodiments, the control system is configured to rotate the tool rollers to engage the conversion tools with predetermined portions of the sheet material at least partially based on the advancement speed of the sheet material.

In some embodiments, the control system is configured to cause the first and second tool rollers on the second axle or axis to be repositioned along the length of the second axle or axis after performing conversion functions to form a first packaging template and prior to performing conversion function to form a second packaging template.

In some embodiments, a mechanism is provided for preventing the sheet material from undesirably folding.

In some embodiments, the mechanism for preventing the sheet material from undesirably folding comprises a plurality of retention elements arranged and configured to hold the sheet material in a bow or arch shape.

In some embodiments, holding the sheet material in a bow or arch shape is configured to keep the sheet material straight in a direction perpendicular to a curvature of the bow or arch, even when the sheet material includes fanfold creased therein.

In some embodiments, the direction perpendicular to a curvature of the bow or arch is parallel to a feed direction of the sheet material through the converting machine.

In some embodiments, the mechanism for preventing the sheet material from undesirably folding comprises one or more rotatable brushes that engages the sheet material and rotates to prevent the sheet material from folding, or even straighten it out if already folded.

According to another embodiment, a method for performing a plurality of conversion functions on sheet material to convert the sheet material into packaging templates includes performing a first subset of conversion functions of the plurality of conversion functions on the sheet material with one or more tool rollers on a first axle or axis and performing a second subset of conversion functions of the plurality of conversion functions on the sheet material with one or more tool rollers on a second axle or axis.

In some embodiments, performing a first subset of conversion functions comprises performing a single conversion function on the sheet material.

In some embodiments, performing a single conversion function comprises cutting the sheet material into separate pieces for use in making separate packaging templates. The separate pieces are arranged successively in a feeding direction of the sheet material.

In some embodiments, performing a first subset of conversion functions comprises performing first and second conversion functions on the sheet material.

In some embodiments, performing the first and second conversion functions comprising performing a separation cut and one or more transverse creases in the sheet material.

In some embodiments, performing a second subset of conversion functions on the sheet material comprises forming one or more longitudinal creases in the sheet material with a set of tool rollers on the second axle or axis.

In some embodiments, performing a second subset of conversion functions on the sheet material comprises cutting side trim from the sheet material with a second set of tool rollers on the second axle or axis.

In some embodiments, the method also includes performing a third subset of conversion functions on the sheet material with one or more tool rollers on a third axle or axis.

In some embodiments, performing a third subset of conversion functions comprises forming one or more transverse cuts in the sheet material with a set of tool rollers on the third axle or axis. The one or more transverse cuts at least partially define one or more flaps of the packaging template.

In some embodiments, performing a third subset of conversion functions further comprises forming one or more longitudinal cuts in the sheet material with a set of tool rollers on the third axle or axis. The one or more longitudinal cuts at least partially define a glue flap of the packaging template.

In some embodiments, the method also includes advancing the sheet material at a generally constant speed while performing the plurality of conversion functions on sheet material to convert the sheet material into packaging templates.

In some embodiments, performing a second subset of conversion functions comprises adjusting the positions of a set of tool rollers along a length of the second axle or axis of a set of tool rollers.

In some embodiments, adjusting the positions of a set of tool rollers comprises symmetrically moving the tool rollers along the length of the second axle or axis.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A converting assembly for performing a plurality of conversion functions on sheet material to convert the sheet material into packaging templates, the converting assembly comprising:
a plurality of tool rollers, each of the tool rollers having one or more conversion tools thereon, the one or more conversion tools on an individual tool roller being configured to perform a subset of the plurality of conversion functions that convert the sheet material into packaging templates.

2. The converting assembly of claim 1, wherein at least some of the plurality of tool rollers are arranged in a series adjacent to one another such that the plurality of tool rollers engage the sheet material sequentially.

3. The converting assembly of claim 1, wherein the plurality of tool rollers comprises a first tool roller on a first axle and at least two tool rollers on a second axle, the first tool roller being selectively rotatable on or about the first axle to selectively engage the one or more conversion tools thereon with the sheet material, and the at least two tool rollers on the second axle being selectively rotatable on or about the second axle to selectively engage the one or more conversion tools on the at least two tool rollers with the sheet material.

4. The converting assembly of claim 3, wherein the first tool roller comprises one or more separation knives, the one or more separation knives being configured to transversely cut the sheet material into separate pieces that can be converted into separate packaging templates, wherein the separate pieces are arranged successively in a feeding direction of the sheet material.

5. The converting assembly of claim 4, wherein the first tool roller further comprises one or more transverse creasing tools, the one or more transverse creasing tools being configured to form transverse creases in the sheet material as part of the conversion of the sheet material into packaging templates.

6. The converting assembly of claim 3, wherein the first tool roller comprises one or more transverse creasing tools, the one or more transverse creasing tools being configured to form transverse creases in the sheet material as part of the conversion of the sheet material into packaging templates.

7. The converting assembly of claim 3, wherein the at least two tool rollers on the second axle comprise first and second tool rollers, each of the first and second tool rollers comprising a longitudinal creasing tool configured to form a longitudinal crease in the sheet material as part of the conversion of the sheet material into packaging templates.

8. The converting assembly of claim 7, wherein the first and second tool rollers are configured to be selectively moved along a length of the second axle.

9. The converting assembly of claim 8, wherein the first and second tool rollers are configured to move symmetrically along the length of the second axle about a centerline of the converting assembly.

10. The converting assembly of claim 7, wherein the at least two tool rollers on the second axle comprises third and fourth tool rollers, each of the third and fourth tool rollers comprising a side trim knife configured to trim off excess side trim from the sheet material as part of the conversion of the sheet material into packaging templates.

11. The converting assembly of claim 10, wherein the third and fourth tool rollers are configured to be selectively moved along a length of the second axle.

12. The converting assembly of claim 11, wherein the third and fourth tool rollers are configured to move symmetrically along the length of the second axle about a centerline of the converting assembly.

13. The converting assembly of claim 10, wherein each of the third and fourth tool rollers comprises one or more additional knives that are configured to cut the excess side trim from the sheet material into smaller pieces.

14. The converting assembly of claim 13, further comprising an attraction element configured to attract the smaller pieces of cut side trim to a desired area.

15. The converting assembly of claim 3, wherein the plurality of tool rollers comprises at least two tool rollers on a third axle, the at least two tool rollers on the third axle being selectively rotatable on or about the third axle to selectively engage the one or more conversion tools on the at least two tool rollers on the third axle with the sheet material.

16. The converting assembly of claim 15, wherein the at least two tool rollers on the third axle comprise first and second tool rollers on the third axle, each of the first and second tool rollers on the third axle comprising one or more flap knives, the one or more flap knives being configured to form cuts in the sheet material to at least partially define flaps in the packaging templates.

17. The converting assembly of claim 15, wherein the at least two tool rollers on the third axle comprise first and second tool rollers on the third axle, each of the first and second tool rollers on the third axle comprising one or more longitudinal knives configured to form longitudinal cuts in the sheet material.

18. The converting assembly of claim 15, wherein the at least two tool rollers on the third axle are configured to be selectively moved along a length of the third axle.

19. The converting assembly of claim 18, wherein the at least two tool rollers are configured to move symmetrically along the length of the third axle about a centerline of the converting assembly.

20. The converting assembly of claim 1, further comprising one or more resilient members positioned adjacent to one or more of the one or more conversion tools.

21. The converting assembly of claim 1, further comprising a drive belt, the drive belt being configured to assist with advancing the sheet material through the converting assembly.

22. The converting assembly of claim 21, wherein the drive belt is configured to limit or prevent the sheet material from folding up or down as the sheet material advances through the sheet material.

23. The converting assembly of claim 1, further comprising one or more brushes positioned adjacent to at least one of the tool rollers, the one or more brushes being configured to limit or prevent the sheet material from folding up or down after the sheet material passes by the at least one of the tool rollers.

24. The converting assembly of claim 1, further comprising one or more support rollers.

25. The converting assembly of claim 24, wherein the one or more support rollers comprise a single support roller positioned opposite the plurality of tool rollers.

26. The converting assembly of claim 24, wherein the one or more support rollers comprise a support roller positioned opposite to each of the plurality of tool rollers.

27. The converting assembly of claim 1, wherein for at least one of the one or more conversion tools, only a portion of the at least one conversion tool is used to perform a conversion function for a packaging template having a first size and a substantial portion of the at least one conversion tool is used to perform a conversion function for a packaging template having a second size.

28. The converting assembly of claim 1, wherein one or more of the tool rollers are configured to have their conversion tools disengaged from the sheet material and repositioned or reoriented while one or more of the other tool rollers are performing conversion functions on the sheet material.

29. A converting machine for converting sheet material into packaging templates, the converting machine comprising:
a feed changer configured to selectively feed sheet materials having different characteristics into the converting machine; and
a converting assembly configured to perform a plurality of conversion functions on the sheet material to convert the sheet material into packaging templates, the converting assembly comprising at least first and second roller sets, wherein:
the first roller set comprises a first tool roller on a first axle, the first tool roller comprising one or more transverse conversion tools thereon, the first tool roller being selectively rotatable on or about the first axle to selectively engage the one or more transverse conversion tools thereon with the sheet material, and
the second roller set comprises at least first and second tool rollers on a second axle, each of the first and second tool rollers on the second axle comprising one or more transverse conversion tools and/or one or more longitudinal conversion tools thereon, the first and second tool rollers being selectively rotatable on or about the second axle to selectively engage the one or more transverse conversion tools and/or the one or more longitudinal conversion tools thereon with the sheet material, the first and second tool rollers being selectively movable along a length of the second axle to reposition the one or more transverse conversion tools and/or the one or more longitudinal conversion tools relative to the sheet material.

30. The converting machine of claim 29, wherein the second roller set further comprises third and fourth tool rollers on the second axle, each of the third and fourth tool rollers comprising one or more transverse conversion tools and/or one or more longitudinal conversion tools.

31. The converting machine of claim 29, wherein the converting assembly further comprises a third roller set, the third roller set having at least first and second tool rollers on a third axle, each of the first and second tool rollers on the third axle having one or more transverse conversion tools and/or the one or more longitudinal conversion tools.

32. The converting machine of claim 29, wherein movements of the first and second tool rollers are symmetrical about a centerline of the converting assembly.

33. The converting machine of claim 29, wherein the feed changer is configured to change which sheet material is fed into the converting machine even while the converting assembly completes the conversion functions on a previous packaging template.

34. The converting machine of claim 29, further comprising an advancement mechanism configured to advance the sheet material through the converting machine.

35. The converting machine of claim 34, wherein the advancement mechanism comprises one or more support rollers positioned opposite to the tool roller.

36. The converting machine of claim 34, wherein the advancement mechanism comprises one or more drive belts.

37. The converting machine of claim 34, further comprising a control system configured to synchronize movements of the tool rollers and a speed at which the advancement mechanism advances the sheet material through the converting machine.

38. The converting machine of claim 37, wherein the control system is configured to rotate the tool rollers to engage the conversion tools with predetermined portions of the sheet material.

39. The converting machine of claim 38, wherein the control system is configured to rotate the tool rollers to engage the conversion tools with predetermined portions of the sheet material at least partially based on the advancement speed of the sheet material.

40. The converting machine of claim 37, wherein the control system is configured to cause the first and second tool rollers on the second axle to be repositioned along the length of the second axle after performing conversion functions to form a first packaging template and prior to performing conversion function to form a second packaging template.

41. The converting machine of claim 29, further comprising a mechanism for preventing the sheet material from undesirably folding.

42. The converting machine of claim 41, wherein the mechanism for preventing the sheet material from undesirably folding comprises a plurality of retention elements, the plurality of retention elements being arranged and configured to hold the sheet material in a bow or arch shape, wherein holding the sheet material in a bow or arch shape is configured to keep the sheet material straight in a direction perpendicular to a curvature of the bow or arch, even when the sheet material includes fanfold creased therein.

43. The converting machine of claim 42, wherein the direction perpendicular to a curvature of the bow or arch is parallel to a feed direction of the sheet material through the converting machine.

44. The converting machine of claim 41, wherein the mechanism for preventing the sheet material from undesirably folding comprises one or more rotatable brushes that engages the sheet material and rotates to prevent the sheet material from folding, and/or straighten out the sheet material if already folded.

45. A method for performing a plurality of conversion functions on sheet material to convert the sheet material into packaging templates, the method comprising:
performing a first subset of conversion functions of the plurality of conversion functions on the sheet material with one or more tool rollers on a first axle;
performing a second subset of conversion functions of the plurality of conversion functions on the sheet material with one or more tool rollers on a second axle.

46. The method of claim 45, wherein performing a first subset of conversion functions comprises performing a single conversion function on the sheet material.

47. The method of claim 46, wherein performing a single conversion function comprises cutting the sheet material into separate pieces for use in making separate packaging templates, wherein the separate pieces are arranged successively in a feeding direction of the sheet material.

48. The method of claim 45, wherein performing a first subset of conversion functions comprises performing first and second conversion functions on the sheet material.

49. The method of claim 48, wherein performing the first and second conversion functions comprising performing a separation cut and one or more transverse creases in the sheet material.

50. The method of claim 45, wherein performing a second subset of conversion functions on the sheet material comprises forming one or more longitudinal creases in the sheet material with a set of tool rollers on the second axle.

51. The method of claim 50, wherein performing a second subset of conversion functions on the sheet material comprises cutting side trim from the sheet material with a second set of tool rollers on the second axle.

52. The method of claim 45, further comprising performing a third subset of conversion functions on the sheet material with one or more tool rollers on a third axle.

53. The method of claim 52, wherein performing a third subset of conversion functions comprises forming one or more transverse cuts in the sheet material with a set of tool rollers on the third axle, the one or more transverse cuts at least partially defining one or more flaps of the packaging template.

54. The method of claim 53, wherein performing a third subset of conversion functions further comprises forming one or more longitudinal cuts in the sheet material with a set of tool rollers on the third axle, the one or more longitudinal cuts at least partially defining a glue flap of the packaging template.

55. The method of claim 45, further comprising advancing the sheet material at a generally constant speed while performing the plurality of conversion functions on sheet material to convert the sheet material into packaging templates.

56. The method of claim 45, wherein performing a second subset of conversion functions comprises adjusting positions of a set of tool rollers along a length of the second axle of a set of tool rollers.

57. The method of claim 56, wherein adjusting the positions of a set of tool rollers comprises symmetrically moving the tool rollers along the length of the second axle.

58. The method of claim 45, further comprising holding the sheet material in a bow or arch shape to keep the sheet material straight in a direction perpendicular to a curvature of the bow or arch and prevent the sheet material from undesirably folding, even when the sheet material includes fanfold creased therein.

59. The method of claim 58, wherein the direction perpendicular to a curvature of the bow or arch is parallel to a feed direction in which the sheet material moves while the first subset of conversion functions and/or the second subset of conversion functions are performed thereon.
